(19) United States
(12) Patent Application Publication
(10) Pub. No.: US 2015/0160897 A1
(43) Pub. Date: Jun. 11, 2015

(54) PRINT CONTROL APPRATUS AND PRINT CONTROL PROGRAM

(71) Applicant: STAR MICRONICS CO., LTD., Shizuoka (JP)

(72) Inventor: Yuji MORI, Shizuoka (JP)

(21) Appl. No.: 14/621,562

(22) Filed: Feb. 13, 2015

Related U.S. Application Data
(63) Continuation of application No. PCT/JP2013/081687, filed on Nov. 26, 2013.

(30) Foreign Application Priority Data
Nov. 28, 2012 (JP) 2012-259538

(51) Int. Cl. G06F 3/12

(52) U.S. Cl. CPC G06F 3/126; G06F 3/1204; G06F 3/1238; G06F 3/1268; G06F 3/1292; G06F 3/1288

(57) ABSTRACT

A user can reliably select a desired printer without a complicated procedure for selecting a printer queue. A print control apparatus acquires identification information for specifying a printer from the printer by NFC communication. Based on the acquired identification information, a printer queue and a corresponding printer driver are selected by application software and printing is executed accordingly. The printer queue corresponding to the printer which the user wants to use for printing can be automatically specified by the application software, so the user does not need to perform a complicated procedure for selecting a printer queue from a list containing misleading names.

### CROSS-REFERENCE TO RELATED APPLICATION

The present application is a continuation of PCT Application No. PCT/JP2013/081687, filed on Nov. 26, 2013, which claims priority to and the benefit of Japanese Patent Application No. 2012-259538 filed on Nov. 28, 2012, the entire contents of which are incorporated herein by reference.

### BACKGROUND

(a) Field

The present invention generally relates a print control apparatus and a print control program. In particular, the present invention generally relates to a control technology at the time when executing printing by selecting a printer queue.

(b) Description of the Related Art

In general, when an information processing terminal such as a personal computer executes printing, the information processing terminal is connected to a printer via a cable. Alternatively, the information processing terminal and the printer is connected to the same network. In the latter case, a single information processing terminal may be connected to a plurality of printers, and may select any one of the plurality of printers to execute the printing. In this case, the information processing terminal stores a plurality of information (printer queues) about available (printable) printers. Generally, a model name of the printer is used as a name for identifying the printer queue.

To start a printing process, the information processing terminal needs to select a printer to be used for the printing. In this case, the information processing terminal selects a printer by specifying a print queue corresponding to the printer available by application software. The printer queue of any default printer may be automatically specified. However, when a user wants to use another printer, it is necessary to select a desired printer queue from listed printer queues to execute the printing (for example, Japanese Patent Application Publication No. 2011-060151).

Each time a new printer is connected (or added) to the information processing terminal or the network environment, a new printer queue is created. Even if the new printer is the same model, the new printer queue is generated if the new printer has a different serial number or different IP address (network address). Therefore, as printers to be connected to the information processing terminal are increased, the printer queues to be registered to the information processing terminal are also increased. The printer queues of the same model are identified by adding a branch number like “model name (1)” and “model name (2)”.

If a lot of printer queues exist, it becomes a cumbersome task to select the printer queue corresponding to the printer to be used for the printing. In addition, if a plurality of printers of the same model name are connected to the network, it is difficult to identify which printer queue corresponds to which printer. Therefore, it is likely that the user wrongly selects the printer queue. In this case, there is a problem that the printing is executed by an undesired printer or by a printer located far from the user.

In recent years, portable tablet devices and smart phones (hereinafter referred to as “mobile terminals”) have been widespread, so demands for executing printing by the mobile terminals are increasing. In particular, it is possible for the user of the mobile terminal to issue a printing instruction in front of the printer which the user wants to use. This prevents the printed matter from being read by others, thus effectively increasing security.

However, simply executing the printing in front of the printer by using the mobile terminal cannot resolve complexity of the printer queue selection. In addition, if a plurality of printer queues having the same model name as the desired printer are displayed in the list, there is a problem that it is not clear which queue should be selected to execute the printing by the printer in front of the user.

### SUMMARY

An embodiment of the present invention is provided to solve the above described problems. An embodiment of the present invention, under an environment in which one information processing terminal capable of selectively using a plurality of printers, allows a user to reliably select a printer which the user wants to use for printing without performing complicated procedures for selecting a printer queue corresponding to the printer which the user wants to use for the printing.

In order to solve the above described problems, an embodiment of the present invention acquires the identification information for specifying a printer to be used for printing from a printer, specifies a printer queue and a corresponding printer driver by application software, and requests a printing execution by using the acquired identification information and the specified printer queue and printer driver.

According to an embodiment of the present invention, since a printer queue corresponding to a printer which a user wants to use for printing can be automatically specified by application software, the user does not need to perform complicated procedures for selecting the printer queue. In addition, since the user does not need to select any one printer queue from a list of printer queues that includes misleading names and an appropriate printer queue is automatically specified by application software, the user can reliably select the printer to be used for the printing.

### BRIEF DESCRIPTION OF THE DRAWINGS

FIG. 1 is a schematic diagram exemplifying a printing system according to a first or second embodiment of the present invention.

FIG. 2 is a block diagram exemplifying a hardware structure of a printing system according to the first or second embodiment.

FIG. 3 is a block diagram exemplifying a software structure of an information processing terminal according to the first embodiment.

FIG. 4 is a flowchart showing an operation example of a printing system according to the first embodiment.

FIG. 5 is a block diagram exemplifying a software structure of an information processing terminal according to the second embodiment.

FIG. 6 is a flowchart showing an operation example of a printing system according to the second embodiment.

### DETAILED DESCRIPTION

In the following detailed description, only certain embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

### First Embodiment

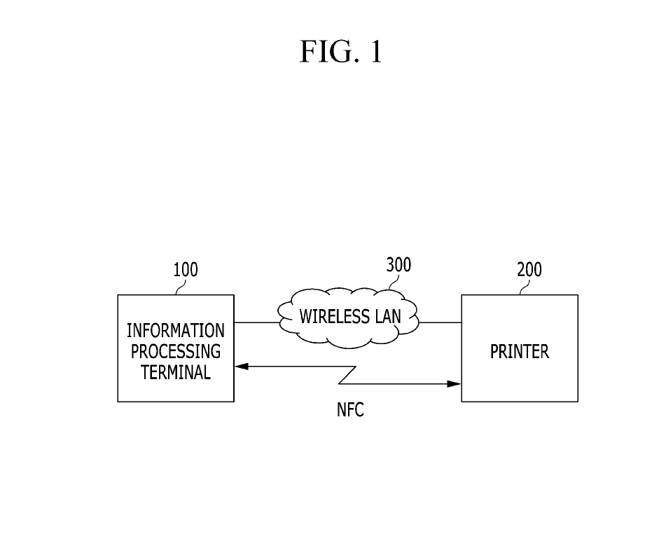

A first embodiment of the present invention is described with reference to the drawings. FIG. 1 is a schematic diagram exemplifying a printing system according to the first embodiment of the present invention. As shown in FIG. 1, the printing system according to the first embodiment includes an information processing terminal 100 and a printer 200. The information processing terminal 100 and the printer 200 are connectable to each other via a wireless LAN (Local Area Network) 300, and can wirelessly communicate with each other via a short-range wireless communication. Hereinafter, the short-range wireless communication is exemplified as NFC (Near Field Communication).

While only one printer 200 is shown in FIG. 1, a plurality of printers 200 may actually exist. The information processing terminal 100 is connected to a selected one of the plurality of printers 200 via the wireless LAN 300, and is able to execute printing using the selected printer 200. The information processing terminal 100 includes a print control apparatus for controlling a printing execution. The information processing terminal 100 is assumed to be a portable mobile terminal such as a smart phone or a tablet device.

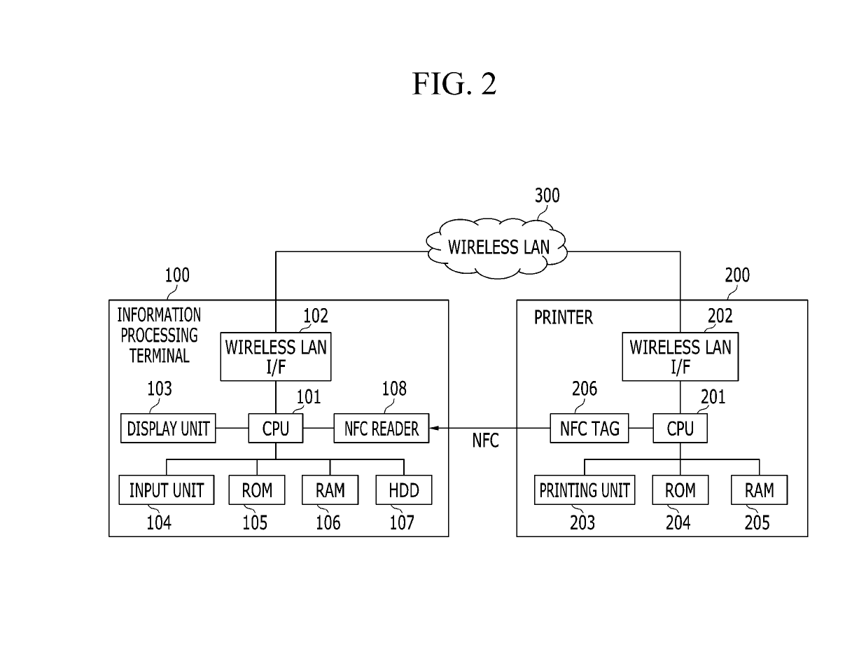

FIG. 2 is a block diagram exemplifying a hardware structure of a printing system according to the first embodiment. As shown in FIG. 2, the information processing terminal 100, as its hardware structure, includes a processor 101, a wireless LAN interface 102, a display unit 103, an input unit 104, a ROM (Read Only Memory) 105, a RAM (Random Access Memory) 106, a storage unit 107, and an NFC reader 108. The processor 101 may include one or more physical processors, and the physical processor may be for example a CPU. Hereinafter, it is assumed that the processor 101 is the CPU. The display unit 103 may be for example a liquid crystal display or an organic light emitting display. The input unit 104 may include for example a touch panel. The storage unit 107 may include for example a hard disk or a memory.

The printer 200, as its hardware structure, includes a processor 201, a wireless LAN interface 202, a printing unit 203, a ROM 204, a RAM 205, and an NFC tag 206. The processor 201 may include one or more physical processors, and the physical processor may be for example a CPU. Hereinafter, it is assumed that the processor 201 is the CPU.

The NFC tag 206 stores identification information for specifying the printer 200 to be used for printing in an embedded memory. In the first embodiment, the stored identification information is queue information (for example, a name of the print queue, etc.) of the printer 200. The NFC tag 206 may be for example a seal type tag that is adhered to a surface of a housing of the printer 200. The NFC tag 206 corresponds to an identification information storage unit of the present embodiment.

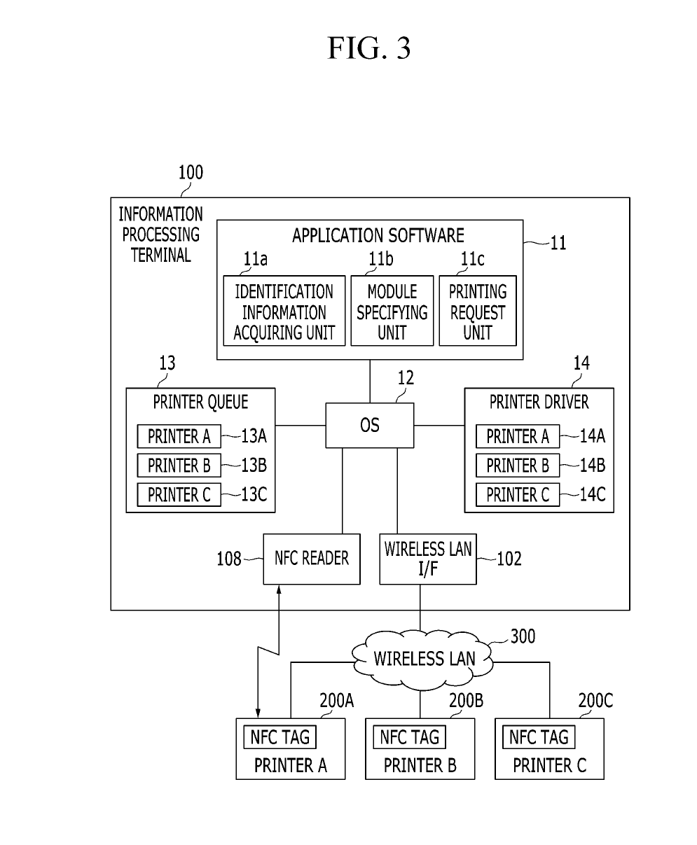

FIG. 3 is a block diagram exemplifying a software structure of the information processing terminal 100 according to the first embodiment. FIG. 3 shows only a main structure of the print control apparatus according to an operation of the first embodiment, and also shows a part of the hardware structure shown in FIG. 2. In FIG. 3, all of three printers 200A, 200B, and 200C are assumed to be the same model. An example shown in FIG. 3 may be the most effective example when the print control apparatus according to the first embodiment is applied, but all of the printers 200A, 200B, and 200B do not need to be the same model. Further, while the three printers 200A, 200B, and 200C are shown in FIG. 3, the number of printers is not limited to three.

As shown in FIG. 3, the information processing terminal 100, as its software structure, includes application software 11, an operating system (OS) 12, a printer queue 13, and a printer driver 14, in addition to the wireless LAN interface 102 and the NFC reader 108 shown in FIG. 2. Further, the application software 11, as its functional structure, includes an identification information acquiring unit 11a, a module specifying unit 11b, and a printing request unit 11c.

Here, at least part of the identification information acquiring unit 11a, the module specifying unit 11b, and the printing request unit 11c may be realized by the application software 11 stored in a recording medium such as the ROM 105, the RAM 106 or the storage unit 107 under control of the CPU 101 shown in FIG. 2. The application software 11 includes a print control program of the present embodiment. In a certain embodiment, the print control program may include at least part of an identification information acquiring module, a module specifying module, and a printing request module which correspond to the identification information acquiring unit 11a, the module specifying unit 11b, and the printing request unit 11c, respectively. Further, each software of the OS 12, the printer queue 13, and the printer driver 14 may be stored for example in the storage unit 107.

In the example shown in FIG. 3, the information processing terminal 100 includes three printer queues 13A, 13B, and 13C which respectively correspond to the three printers 200A, 200B, and 200C, and three printer drivers 14A, 14B, and 14C which respectively correspond to the three printers 200A, 200B, and 200C. That is, the information processing terminal 100 can select any one from among the three printers 200A, 200B, and 200C, connect to the selected printer via the wireless LAN 300, and execute printing using the selected printer.

Further, when the information processing terminal 100 is described with reference to FIG. 3, it is assumed that the three printers 200A, 200B, and 200C are collectively called the printer 200, the three printer queues 13A, 13B, and 13C are collectively called the printer queue 13, and the three printer drivers 14A, 14B, and 14C are collectively called the printer driver 14.

The identification information acquiring unit 11a of the application software 11 acquires queue information (for example, a name of the printer queue 13) stored in the NFC tag 206 (for example, the identification information storage unit) of the printer 200 by NFC communication in cooperation with the OS 12 and the NFC reader 108. That is, when the user presses a print button shown on the display unit 103, the identification information acquiring unit 11a requests the OS 12 to perform a reading by the NFC reader 108 and displays a message on the display unit 103 saying, for example, “Please touch the printer with the NFC reader.”

Upon viewing the message, the user places the information processing terminal 100 with the built-in NFC reader 108 close to the NFC tag 206 of the printer 200. Accordingly, the NFC reader 108 reads the queue information of the printer 200 from the NFC tag 206. As is well known, the communication distance of NFC is less than 10 cm. Therefore, in order to allow the NFC reader 108 to read the queue information from the NFC tag 206 attached to the printer 200, it is necessary to place the information processing terminal 100 close to the printer 200.

In the present embodiment, a selection of the printer 200 to be used for printing is performed by placing the information processing terminal 100 close to a desired printer 200. In the example shown in FIG. 3, the printer 200A is selected and the queue information (the name of the printer queue 13A) of the selected printer 200A is read, by placing the information processing terminal 100 close to the printer 200A. The NFC reader 108 transfers the read queue information to the OS 12, and the OS 12 provides the queue information to the identification information acquiring unit 11a of the application software 11.

The module specifying unit 11b specifies a printer module to be used for printing in cooperation with the OS 12 by specifying the printer queue 13 based on the queue information acquired by the identification information acquiring unit 11a, and further specifies the corresponding printer driver 14 for the specified printer queue 13. In the example shown in FIG. 3, the module specifying unit 11b specifies the printer queue 13A from the list of the printer queues 13 based on the name of the printer queue acquired by the identification information acquiring unit 11a, and further specifies the corresponding printer driver 14A for the specified printer queue 13A.

The printing request unit 11c issues a printing request in cooperation with the OS 12 by sending print data to the printer driver 14 specified by the module specifying unit 11b based on the specified printer queue 13. In the example shown in FIG. 3, the printing request unit 11c sends the print data to the printer driver 14A specified by the module specifying unit 11b based on the specified printer queue 13A, thereby requesting a printing execution.

When receiving the request, the printer driver 14A transmits the print data via the wireless LAN 300 to the printer 200A (i.e., the printer 200A whose queue information is acquired from the NFC tag 206 by the identification information acquiring unit 11a) which is to be driven by the printer driver 14A, thereby instructing the printing execution. The printing unit 203 of the printer 200A, upon receiving the instruction, executes the printing. Location information (for example, an IP address) of the printer 200A required for connection with the information processing terminal 100 via the wireless LAN 300 is previously set in the printer driver 14A.

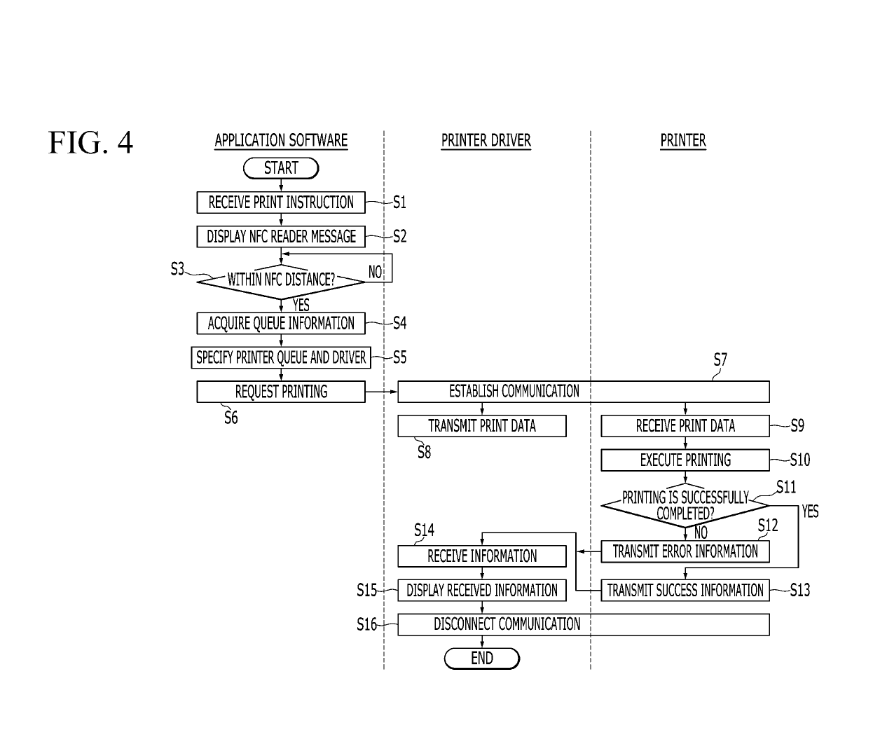

FIG. 4 is a flowchart showing an operation example of a printing system according to the first embodiment. Referring to FIG. 4, when the application software 11 recognizes that the print button is pressed in the input unit 104 of the information processing terminal 100 (step S1), the identification information acquiring unit 11a of the application software 11 requests the OS 12 to perform a reading by the NFC reader 108 and displays the message on the display unit 103 saying, for example, “Please touch the printer with the NFC reader.” (step S2). Upon viewing the message, the user places the information processing terminal 100 with the built-in NFC reader 108 close to the NFC tag 206 of the printer 200.

Then, the NFC reader 108, under control of the identification information acquiring unit 11a, determines whether the information processing terminal 100 is brought close to the NFC tag 206 of the printer 200 within the NFC communication distance (step S3). When the information processing terminal 100 is brought close to the NFC tag 206 within the NFC communication distance, the NFC reader 108 acquires the queue information stored in the NFC tag 206 by NFC communication (step S4). The queue information acquired by NFC reader 108 is provided to the identification information acquiring unit 11a of the application software 11 via the OS 12.

Next, the module specifying unit 11b of the application software 11, in cooperation with the OS 12, specifies the printer queue 13 corresponding to the queue information acquired by the identification information acquiring unit 11a, and further specifies the corresponding printer driver 14 for the specified printer queue 13 (step S5). In addition, the printing request unit 11c of the application software 11 issues an printing request in cooperation with the OS 12 by sending print data to the printer driver 14 specified by the module specifying unit 11b based on the specified printer queue 13 (step S6).

Upon receiving the print request, the printer driver 14 controls the wireless LAN interface 102 to establish a communication of the wireless LAN 300 with the printer 200 specified by the IP address set in the printer driver 14 (step S7). The printer driver 14 transmits the print data to the printer 200 to instruct the printing execution (step S8).

The printing unit 203 of the printer 200 receives the print data from the information processing terminal 100 (step S9), and executes the printing (step S10). Then, the printing unit 203 determines whether the printing has been successfully completed (step S11). Here, when the printing fails, the printing unit 203 sends error information to the information processing terminal 100 via the wireless LAN 300 (step S12). When the printing has been successfully completed, the printing unit 203 transmits success information to the information processing terminal 100 via the wireless LAN 300 (step S13).

The information processing terminal 100 receives the error information or the success information from the printer 200 (step S14), and displays the received information on the display unit 103 (step S15). Next, the wireless LAN interface 102 disconnects the communication established between the information processing terminal 100 and the printer 200 in step S7 (step S16). Accordingly, the process of the flowchart exemplified in FIG. 4 ends.

As described above in detail, in the first embodiment, the application software 11 enables an acquisition of the queue information of the printer 200 from the NFC tag 206 attached to the printer 200 by NFC communication, and further enables a selection of the printer queue 13 and the printer driver 14 to be used for printing based on the acquired information.

According to the first embodiment, since the printer queue 13 corresponding to the printer 200 which the user wants to use for the printing can be automatically selected by the application software 11, the user does not need to perform complicated procedures for selecting the printer queue 13. Furthermore, the user does not need to select any one printer queue from a list of printer queues 13 that includes misleading names of the same model, and the appropriate printer queue 13 can be automatically selected by the application software 11. Therefore, the user can reliably select the printer 200 to be used for the printing.

### Second Embodiment

A second embodiment of the present invention is described with reference to the drawings. An overview structure of a printing system according to the second embodiment is the same as the structure shown in FIG. 1. The hardware structure of the printing system according to the second embodiment is the same as the structure shown in FIG. 2. The NFC tag 206 stores identification information for specifying the printer 200 to be used for printing in an embedded memory. In the second embodiment, the stored identification information is printer information (for example, an IP address) of the printer 200.

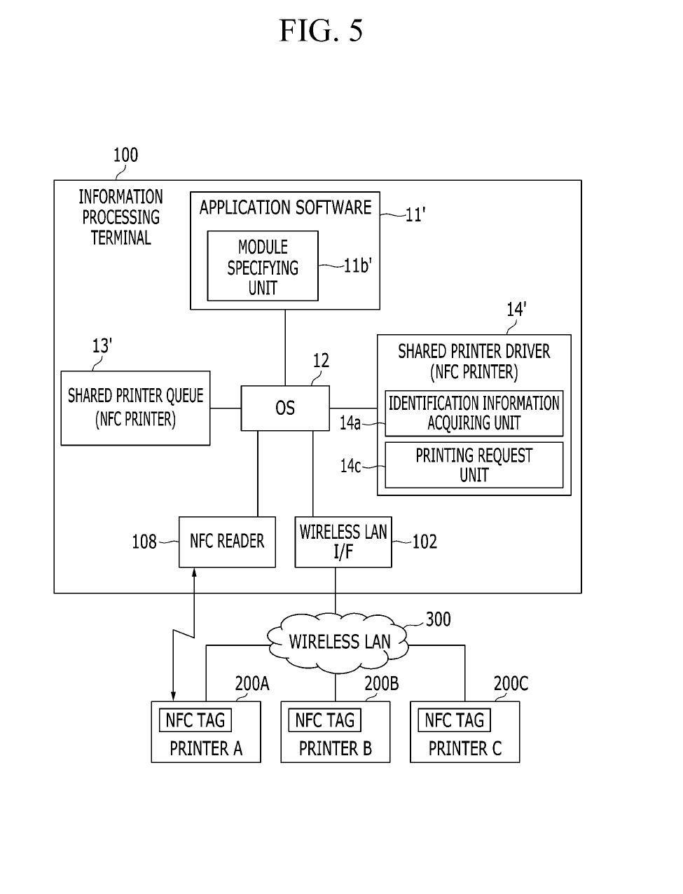

FIG. 5 is a block diagram exemplifying a software structure of the information processing terminal 100 according to the second embodiment. In FIG. 5, since blocks denoted by the same reference numbers as shown in FIG. 3 have the same functions as blocks of FIG. 4, duplicated description will be omitted. In FIG. 5, it is assumed that all of three printers 200A, 200B, and 200C are assumed to be the same model. Further, while the three printers 200A, 200B, and 200C are shown in FIG. 5, the number of printers is not limited to three.

As shown in FIG. 5, the information processing terminal 100 according to the second embodiment includes application software 11′, a shared printer queue 13′, and a shared printer driver 14′ in place of the application software 11, the printer queue 13, and the printer driver 14 shown in FIG. 3. The application software 11′, the shared printer queue 13′, and the shared printer driver 14′ have different functions from the application software 11, the printer queue 13, and the printer driver 14. The application software 11′ includes a module specifying unit 11b′ and the shared printer driver 14′ includes an identification information acquiring unit 14a and a printing request unit 14c.

Here, a function of the module specifying unit 11b′ may be realized by the application software 11′ stored in a recording medium such as the ROM 105, the RAM 106 or the storage unit 107 under control of the CPU 101 shown in FIG. 2. Further, functions of the identification information acquiring unit 14a and the printing request unit 14c may be realized by an operation of the shared printer driver 14′ stored in a recording medium such as the ROM 105, the RAM 106 or the storage unit 107 under control of the CPU 101 shown in FIG. 2. The shared printer driver 14′ includes a print control program of the present embodiment. In a certain embodiment, the print control program may include at least part of the identification information acquiring module and the printing request module which correspond to the specifying information acquiring unit 14a and the printing request unit 14c, respectively.

In the second embodiment, the information processing terminal 100 includes the shared printer queue 13′ shared by the three printers 200A, 200B, and 200C, and the shared printer driver 14′ shared by the three printers 200A, 200B, and 200C. That is, the information processing terminal 100 according to the second embodiment uses the shared printer queue 13′ and the shared printer driver 14′ even though any printer is selected for printing from among the three printers 200A, 200B, and 200C. Since the shared printer driver 14′ is not predetermined to issue an instruction of the printing to which printer, the IP address of a specific printer 200 is not set to the shared printer driver 14′.

When the user presses a print button on the display unit 103 displayed by the application software 11′, the module specifying unit 11b′ of the application software 11′ specifies a printer module to be used for printing in cooperation with the OS 12 by specifying the shared printer queue 13′ and the corresponding shared printer driver 14′ for the shared printer queue 13′.

The identification information acquiring unit 14a of the shared printer driver 14′, in cooperation with the OS 12 and the NFC reader 108, acquires printer information (for example, an IP address of the printer 200) from the NFC tag 206 (for example, an identification information storage unit) of the printer 200 by NFC communication.

That is, if the module specifying unit 11b′ specifies the shared printer driver 14′ in response to the operation of the print button, the identification information acquiring unit 14a of the shared printer driver 14′ requests the OS 12 to perform a reading by the NFC reader 108 and displays a message on the display unit 103 saying, for example, “Please touch the printer with the NFC reader.”

Upon viewing the message, the user places the information processing terminal 100 with the built-in NFC reader 108 close to the NFC tag 206 of the printer 200. Accordingly, the NFC reader 108 reads the printer information from the NFC tag 206. Therefore, in the second embodiment, a selection of the printer 200 to be used for printing is selected by placing the information processing terminal 100 close to the desired printer 200.

In the example shown in FIG. 5, the printer 200A is selected and the printer information of the printer 200A is read, by placing the information processing terminal 100 close to the printer 200A. The NFC reader 108 transfers the read printer information to the OS 12, and then the OS 12 transfers the printer information to the identification information acquiring unit 14a of the shared printer driver 14′.

The printing request unit 14c, in cooperation with the OS 12, receives the print data from the application software 11′ by using the shared printer queue 13′ specified by the module specifying unit 11b′. Further, the printing request unit 11c, in cooperation with the OS 12, requests a printing execution by sending the print data via the wireless LAN 300 to the printer 200A specified by the printer information (for example, the IP address) acquired by the identification information acquiring unit 14a. The printing unit 203 of the printer 200A executes the printing in response to this request.

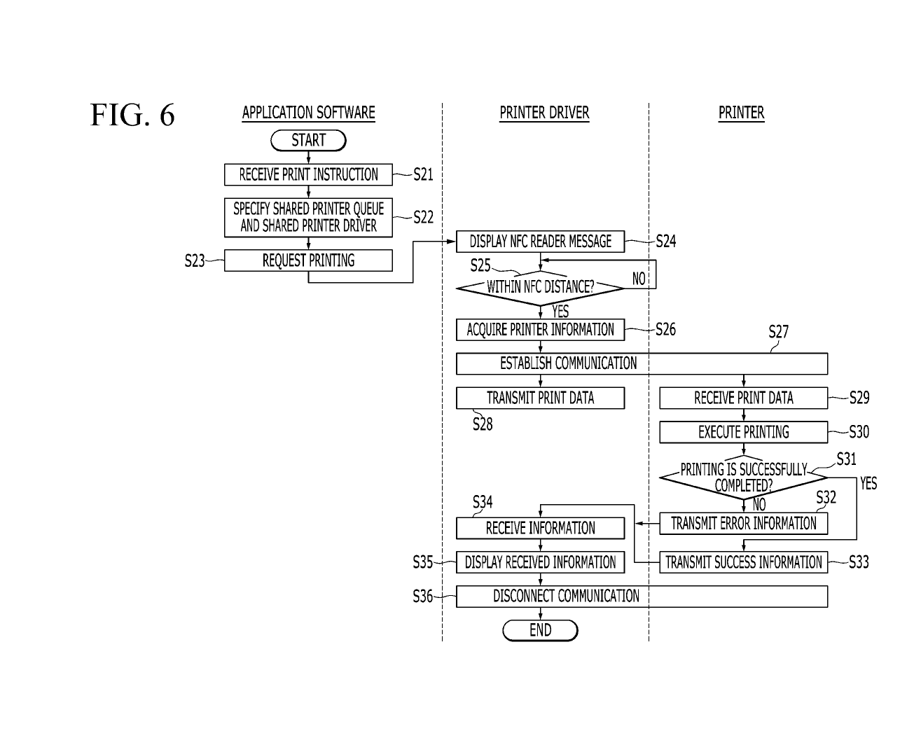

FIG. 6 is a flowchart showing an operation example of a printing system according to the second embodiment. Referring to FIG. 6, when the application software 11′ recognizes that the print button is pressed in the input unit 104 of the information processing terminal 100 (step S21), the module specifying unit 11b′ of the application software 11′, in cooperation with the OS 12, specifies the shared printer queue 13′ and the shared printer driver 14′ (step S22).

In addition, the module specifying unit 11b′ of the application software 11′, in cooperation with the OS 12, sends the print data to the shared printer driver 14′ specified by the module specifying unit 11b′ based on the specified shared printer queue 13′, thereby requesting a printing execution (step S23).

Upon receiving the print request, the identification information acquiring unit 14a of the shared printer driver 14′ requests the OS 12 to perform a reading by the NFC reader 108, and displays a message on the display unit 103 saying, for example, “Please touch the printer with the NFC reader” (step S24). Upon viewing the message, the user places the information processing terminal 100 with the built-in NFC reader 108 close to the NFC tag 206 of the printer 200.

Then, the NFC reader 108, under control of the identification information acquiring unit 11a, determines whether the information processing terminal 100 is brought close to the NFC tag 206 of the printer 200 within the NFC communication distance (step S25). When the information processing terminal 100 is brought close to the NFC tag 206 within the NFC communication distance, the NFC reader 108 acquires the printer information (for example, the IP address of the printer 200) stored in the NFC tag 206 by NFC communication (step S26). The printer information acquired by NFC reader 108 is provided to the specifying information acquiring unit 11a of the shared printer driver 14′ via the OS 12.

Next, the printing request unit 14c of the shared printer driver 14′ controls the wireless LAN interface 102 to establish a communication of the wireless LAN 300 with the printer 200 specified by the IP address acquired in step 26 (step S27). The printing request unit 14c transmits the print data to the printer 200 to instruct the printing execution (step S28).

The printing unit 203 of the printer 200 receives the print data from the information processing terminal 100 (step S29), and executes the printing (step S30). Then, the printing unit 203 determines whether the printing has been successfully completed (step S31). Here, when the printing has ended in failure, the printing unit 203 sends error information to the information processing terminal 100 via the wireless LAN 300 (step S32). When the printing has been successfully completed, the printing unit 203 transmits success information to the information processing terminal 100 via the wireless LAN 300 (step S33).

The information processing terminal 100 receives the error information or the success information from the printer 200 (step S34), and displays the received information on the display unit 103 (step S35). Next, the wireless LAN interface 102 disconnects the communication established between the information processing terminal 100 and the printer 200 in step S27 (step S36). Accordingly, the process of the flowchart exemplified in FIG. 6 ends.

As described above in detail, in the second embodiment, after the shared printer queue 13′ and the shared printer driver 14′ are automatically specified by the application software 11′, the function of the shared printer driver 14′ enables an acquisition of the printer information (for example, the IP address) from the NFC tag 206 attached to the printer 200 to be used for printing by NFC communication, and enables an instruction of the printing execution to the printer 200 corresponding to the acquired printer information.

According to the second embodiment, since the shared printer queue 13′ that can be commonly used for the printer 200 which the user wants to use for the printing is automatically specified by the application software 11′, the user does not need to perform complicated procedures for selecting the shared printer queue 13′. In addition, the printer 200 is specified based on the IP address acquired from the NFC tag 206 by using the shared printer queue 13′ and the shared printer driver 14′ that are automatically specified by the application software 11′, the user does not need to select any one printer queue from a list of printer queues that includes misleading names of the same model. Therefore, the user can reliably select the printer 200 to be used for the printing.

Further, according to the second embodiment, since it is sufficient that one shared printer queue 13′ is prepared for a plurality of printers 200, the number of printer queues that are stored in the information processing terminal 100 can be reduced. Since the number of printer queues to be prepared can be reduced, the amount of memory to be used to store the printer queues can be reduced.

Furthermore, according to the second embodiment, since the application software 11′ merely specifies shared printer queue 13′ and the shared printer driver 14′ and sends the printer data to the shared printer driver 14′, the application software 11′ does not need to acquire information from the printer 200 by NFC communication. Therefore, the load of the application software 11′ can be reduced as compared to the first embodiment.

Moreover, according to the second embodiment, it is possible to reduce a load of a system integrator creating the application software 11′. In the first embodiment, the system integrator is requested to create an NFC reading program for every application software 11′ for every different client. However, this is a very complicated task.

In contrast, the shared printer driver 14′ is created by a printer vendor. Typically, the same printer driver is provided to the printers 200 of the same model. Therefore, if the printer vendor creates the shared printer driver 14′ by incorporating the NFC reading function into the printer driver to be provided to the printers of the same model, it is not necessary to incorporate the complicated NFC reading program into the application software 11′.

Therefore, in the second embodiment, the system integrator is not requested to create an NFC reading program for every application software 11′ for every different client. A printing system utilizing NFC is simply constructed. In addition, in case that the printing system is re-built by adding a printer 200 of the same model to the printing system, there is no need to re-create the application software 11′. Therefore, maintenance of the printing system is very easy.

Further, while it has been exemplified in the above-described second embodiment that the three printers 200A, 200B, and 200C are assumed to be the same model, the printers may be different models. In another embodiment, the shared printer queue 13′ may be used for the printer queue, but the printer drivers that respectively correspond to the models of the three printers 200A, 200B, and 200C may be prepared in addition to the shared printer driver 14′. Further, the NFC tag 206 of the printer 200 may store model information of the printer 200 in the embedded memory as well as the location information (for example, the IP address) of the printer 200.

In this case, the identification information acquiring unit 14a of the shared printer driver 14′, in cooperation with the OS 12 and the NFC reader 108, may acquire the printer information (for example, the IP address and the model information of the printer 200) stored in the NFC tag 206 of the printer 200 by NFC communication. Then, the printing request unit 14c specifies a printer driver of the corresponding model from among the printer drivers 14A, 14B, and 14C based on the model information acquired by the identification information acquiring unit 14a, and instructs the printing executing to the printer 200 specified by the IP address acquired by the identification information acquiring unit 14a by using the selected printer driver.

Accordingly, the second embodiment can be applied to the case that the three printers 200A, 200B, and 200C are the different models. As a result, this case can also provide the effects according to the second embodiment described above.

While it has been described in the above described first and second embodiments that the information processing terminal 100 acquires the identification information from the printer 200 by NFC communication, the present invention is not limited thereto. In another embodiment, a bar code may be attached to or printed on the printer 200, and may be captured by a camera of the information processing terminal 100. Accordingly, the information processing terminal 100 can acquire from the printer 200 the identification information indicated by the bar code.

In a certain embodiment, the print data generated by the application software 11 or 11′ according to the first or second embodiment may be one that depends on the model of the printer 200 or may be one that does not depend on the model of the printer 200. If the application software 11 or 11′ generates the print data (which do not depend on the model of the printer 200) which cannot be interpreted by the printer 200, the printer driver 14 or 14′ converts the print data into print data that can be interpreted by the printer 200. On the other hand, if the application software 11 or 11′ generates the print data (which depend on the model of the printer 200) which can be interpreted by the printer 200, the printer driver 14 or 14′ is not required to convert the print data. Therefore, when establishing the communication with the printer 200, the printer driver 14 or 14′ can transmit the print data directly to the printer 200.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

What is claimed is:

1. A print control apparatus in an information processing terminal including application software, a printer queue, and a printer driver, comprising:
an identification information acquiring unit configured to acquire identification information for specifying a printer to be used for printing from an identification information storage unit of the printer;
a module specifying unit configured to specify a printer module to be used for printing by specifying the printer queue and the corresponding printer driver by the application software; and
a printing request unit configured to issue a printing request by using the identification information acquired by the identification information acquiring unit and the printer queue and the corresponding printer driver specified by the module specifying unit.

2. The print control apparatus of claim 1, wherein the printer queue is shared by a plurality of printers, the printer driver is shared by the plurality of printers, the module specifying unit is included in the application software, and the identification information acquiring unit and the printing request unit are included in the shared printer driver,
wherein the module specifying unit is configured to specify the shared printer queue and the corresponding shared printer driver in response to an instruction for printing,
wherein the identification information acquiring unit is configured to acquire printer information for specifying the printer from the identification information storage unit of the printer, and
wherein the printing request unit is configured to issue the printing request by transmitting print data to the printer specified by the printer information acquired by the identification information acquiring unit.

3. The print control apparatus of claim 2, wherein the printer information includes location information of the printer, and
wherein the printing request unit issues the printing request by transmitting print data to the printer specified by the location information acquired by the identification information acquiring unit.

4. The print control apparatus of claim 3, wherein the location information includes an Internet Protocol address.

5. The print control apparatus of claim 2, wherein the printer driver is further provided for each of the plurality of printers,
wherein the printer information includes location information and model information of each of the plurality of printers,
wherein the printing request unit is configured to select the corresponding printer driver based on the model information acquired by the identification information acquiring unit, and to use the selected printer driver to issue the printing request by transmitting print data to the printer specified by the location information acquired by the identification information acquiring unit.

6. The print control apparatus of claim 5, wherein the location information includes an Internet Protocol address.

7. The print control apparatus of claim 1, wherein the printer queue is provided for each of a plurality of printers, the printer driver is provided for each of the plurality of printers, and the identification information acquiring unit, the module specifying unit, and the printing request unit are included in the application software,
wherein the identification information acquiring unit is configured to acquire queue information for specifying the printer queue from the identification information storage unit of the printer,
wherein the module specifying unit is configured to specify the printer queue based on the queue information acquired by the identification information acquiring unit and the corresponding printer driver, and
wherein the printing request unit is configured to issue the printing request by transmitting print data to the printer driver specified by the module specifying unit based on the specified printer queue.

8. The print control apparatus of claim 1, wherein the identification information acquiring unit is configured to acquire the identification information from the identification information storage unit of the printer by near field communication.

9. The print control apparatus of claim 8, wherein the identification information acquiring unit is configured to display on the information processing terminal a message requesting to place the information processing terminal close to the printer used for printing in order to acquire the identification information from the printer.

10. A recording medium that stores a print control program configured to be incorporated into a printer driver in an information processing terminal including application software, a printer queue to be shared by a plurality of printers, and the printer driver to be shared by the plurality of printers, the printer control program comprising:
an identification information acquiring module configured to acquire printer information from an identification information storage unit of the printer after the shared printer queue and the corresponding shared printer driver are specified by the application software in response to an instruction for printing; and
a printing request module configured to issue an printing request by transmitting print data to the printer specified by the printer information acquired by the identification information acquiring module.

11. The recording medium of claim 10, wherein the printer driver is further provided for each of the plurality of printers,
wherein the printer information includes location information and model information of each of the plurality of printers,
wherein the printing request unit is configured to select the corresponding printer driver based on the model information acquired by the identification information acquiring model, and to use the selected printer driver to issue the printing request by transmitting the print data to the printer specified by the location information acquired by the identification information acquiring module.

12. The recording medium of claim 11, wherein the location information includes an Internet Protocol address.

13. The recording medium of claim 10, wherein the printer information includes location information of each of the plurality of printers, and
wherein the printing request module is configured to issue the printing request by transmitting the print data to the printer specified by the location information acquired by the identification information acquiring module.

14. The recording medium of claim 13, wherein the location information includes an Internet Protocol address.

15. The recording medium of claim 10, wherein the identification information acquiring module is configured to acquire the printer information from the identification information storage unit of the printer by near field communication.

16. The recording medium of claim 15, wherein the identification information acquiring module is configured to display on the information processing terminal a message requesting to place the information processing terminal close to the printer used for printing in order to acquire the printer information from the printer.

17. A recording medium that stores a print control program configured to be incorporated into application software in an information processing terminal including the application software, a plurality of printer queues respectively corresponding to a plurality of printers, and a plurality of printer drivers respectively corresponding the plurality of printers, the print control program comprising:
an identification information acquiring module configured to acquire queue information for specifying the printer queue from an identification information storage unit of a printer;
a module specifying module configured to specify the printer queue based on the queue information acquired by the identification information acquiring module and the corresponding printer driver; and
a printing request module configured to issue a printing request by transmitting print data to the printer driver specified by the module specifying module based on the specified printer queue.

18. The recording medium of claim 17, wherein the identification information acquiring module is configured to acquire the queue information from the identification information storage unit of the printer by near field communication.

19. The recording medium of claim 18, wherein the identification information acquiring module is configured to display on the information processing terminal a message requesting to place the information processing terminal close to the printer used for printing in order to acquire the queue information from the printer.
